(19) United States
(12) Patent Application Publication
(10) Pub. No.: US 2012/0007366 A1
(43) Pub. Date: Jan. 12, 2012

(54) VARIABLE AREA VERTICAL AXIS WIND TURBINE

(76) Inventor: Ralph A. Belden, Minden, NV (US)

(21) Appl. No.: 13/257,884

(22) PCT Filed: Mar. 19, 2010
(86) PCT No.: PCT/US10/28015

§ 371 Date: Sep. 20, 2011

Related U.S. Application Data
(60) Provisional application No. 61/210,673, filed on Mar. 20, 2009.

(51) Int. Cl. F03D 3/06; F03D 9/00

(52) U.S. Cl. 290/55; 416/117

(57) ABSTRACT

A vertical axis wind turbine according to embodiments of the present invention includes a hub, first and second rotor arms rigidly coupled to the hub, a first rotor blade pivotably coupled to the first rotor arm at a first hinge joint, a second rotor blade pivotably coupled to the second rotor arm at a second hinge joint, such that the first hinge joint is the only point of contact between the first rotor blade and any other part of the vertical axis wind turbine, and the second hinge joint is the only point of contact between the second rotor blade and any other part of the vertical axis wind turbine.

### CROSS-REFERENCE TO RELATED APPLICATION

This application claims the benefit of U.S. Provisional Patent Application Ser. No. 61/210,673, filed on Mar. 20, 2009, and entitled “Variable Area Vertical Axis Wind Turbine,” the contents of which are incorporated herein by reference.

### TECHNICAL FIELD

Embodiments of the present invention relate generally to wind power generation, and more specifically to vertical axis wind turbines.

### BACKGROUND

Over 87% of the land mass of the Earth experiences Class 2 wind speeds, which are too weak to cost effectively generate energy with existing wind turbine technology. Class 2 winds, which blow at 4.5 meters per second, contain approximately 100 to 150 Watts of usable power per square meter. By comparison, Class 6 winds, required for most conventional turbines to operate cost effectively, contain 1,000 Watts of power per square meter.

### SUMMARY

A vertical axis wind turbine according to an embodiment of the present invention includes a hub configured to rotate about an axis of rotation substantially aligned with a gravitational force, a first rotor arm rigidly coupled to the hub, a second rotor arm rigidly coupled to the hub, a first rotor blade pivotably coupled to the first rotor arm at a first hinge joint, such that the first rotor blade rotates freely about the first rotor arm at the first hinge joint, the first rotor blade having a first upper end and a first lower end, and a second rotor blade pivotably coupled to the second rotor arm at a second hinge joint, such that the second rotor blade rotates freely about the second rotor arm at the second hinge joint, the second rotor blade having a second upper end and a second lower end. According to such embodiment, a first length of the first rotor blade from the hinge joint to the first lower end is longer than a second length of the first rotor blade from the hinge joint to the first upper end, a third length of the second rotor blade from the hinge joint to the second lower end is longer than a fourth length of the second rotor blade from the hinge joint to the second upper end, the first hinge joint is the only point of contact between the first rotor blade and any other part of the vertical axis wind turbine, and the second hinge joint is the only point of contact between the second rotor blade and any other part of the vertical axis wind turbine.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates a front elevation view of a vertical axis wind turbine, according to embodiments of the present invention.

FIG. 2 illustrates a top plan view of a vertical axis wind turbine and an enlarged view of a rotor blade and hinge joint, according to embodiments of the present invention.

FIG. 3 illustrates a top, side, and cross-sectional view of an alternative rotor arm, according to embodiments of the present invention.

FIG. 4 illustrates a perspective view of a vertical axis wind turbine having three rotor arms and three rotor blades, according to embodiments of the present invention.

FIG. 5 illustrates a top plan view of a vertical axis wind turbine having three rotor arms and three rotor blades, according to embodiments of the present invention.

FIG. 6 illustrates an enlarged view of one of the rotor blades of the vertical axis wind turbine of FIG. 5, according to embodiments of the present invention.

FIG. 7 depicts a plot comparing power output and tilt angle over a range of wind speeds, according to embodiments of the present invention.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

To generate the same amount of energy in Class 2 winds as can be generated in Class 6 winds, a much larger rotor area, or “capture area,” is employed. The power output of a wind generator is proportional to the swept area of the rotor, such that when the swept area is doubled, the power output will also double, for a given wind speed. The power output of a wind generator is also proportional to the cube of the wind speed, such that doubling the wind speed causes the power output to increase by a factor of eight, for a given swept area. This example illustrates that even relatively small increases in wind speed for a given rotor swept area can result in very large power increases, and hence very large increases in wind forces experienced by the rotors and other hardware. As such, most existing wind generators are unable to operate across multiple categories of wind speeds without a significant risk of failure.

According to an embodiment of the present invention, a wind turbine changes its rotor area (e.g. “swept area”), in order to match and/or accommodate wind speed changes.

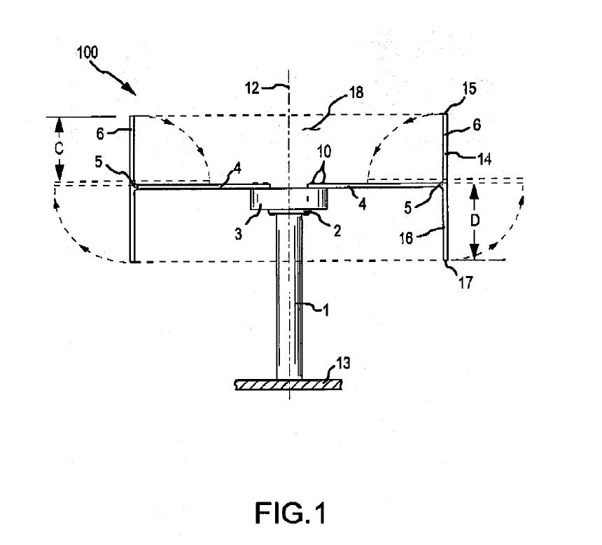

FIG. 1 illustrates a front elevation view of a vertical axis wind turbine 100, according to embodiments of the present invention. Turbine 100 includes a hub 3 configured to rotate about an axis of rotation 12 substantially aligned with a gravitational force. As used herein, the terms top, bottom, up, down, above, under, vertical, horizontal, and upright are used in their traditional sense to refer to directions with reference to and with respect to the direction of the gravitational force. FIG. 1 shows a vertical axis wind turbine with a plurality of rotor blades revolving around a central axis which is connected to an electrical generating device or a gear mechanism to drive mechanical items, such as, for example, a water pump.

Turbine 100 further includes one or more rotor arms 4 coupled to the hub 3, according to embodiments of the present invention. For example, the rotor arms 4 may be rigidly coupled to the hub 3 via one or more attachment bolts 10. The hub 3 may be an alternator, and/or may be part of an alternator, such that rotation of the rotor arms 4 rotates the alternator 3 and generates electrical energy, according to embodiments of the present invention. The hub 3 may be coupled to a mounting plate 2, and the mounting plate 2 may be coupled and/or formed integrally with a support post 1 or tower, and the support post may be coupled and/or formed integrally with a mount 13, according to embodiments of the present invention. Hub 3 may also be a gearing device used to drive mechanical equipment such as, for example, a water pump or other rotating machinery.

As used herein, the term “coupled” is used in its broadest sense to refer to elements which are connected, attached, and/or engaged, either directly or integrally or indirectly via other elements, and either permanently, temporarily, or removably. As used herein, the terms “rotatably coupled” and “pivotably coupled” are used in their broadest sense to refer to elements which are coupled in a way that permits one element to rotate or pivot with respect to another element.

A rotor blade 6 may be rotatably and/or pivotably coupled to the rotor arm 4. The pivotable coupling between rotor blade 6 and rotor arm 4 may be accomplished with a hinge joint 5, according to embodiments of the present invention. The rotor blade 6 rotates freely about the rotor arm 4 at the hinge joint 5, according to embodiments of the present invention. The rotor blade 6 rotates from an upright or vertical position, shown in solid lines in FIG. 1, to a horizontal position, or a position in which the rotor blade 6 is substantially flat against the rotor arm 4, shown in dashed lines in FIG. 1, according to embodiments of the present invention. As such, the rotor blade 6 moves through a ninety-degree arc, according to embodiments of the present invention. According to some embodiments of the present invention, the rotor blade 6 is capable of moving through an approximately 180 degree arc about the rotor arm 4. According to some embodiments of the present invention, the rotor blade 6 is capable of moving through an approximately ninety degree arc about the rotor arm 4. This permits the swept area to change from nearly 100% to nearly 0%, according to embodiments of the present invention.

The rotor blade 6 includes a top length 14 extending between the hinge pivot point 5 and the top 15 of the rotor blade 4, and also a bottom length 16 extending between the hinge pivot point 5 and the bottom 17 of the rotor blade 4, according to embodiments of the present invention. The length D of the bottom length 16 is larger than the length C of the top length 14, according to embodiments of the present invention. This has the effect of unbalancing the weight of the blade so that one end, as measured from the hinge pivot 5, is heavier than the other. The rotor blade 6 is attached to the rotor arm 4 in such a way that the long end (heavy end) is in the downward position.

As the rotor blade 6 and rotor arm 4 rotate about the axis 12, a centrifugal force is applied to the rotor blade 6; when the rotor blade 6 is of uniform cross section and density (which also corresponds to the simplest and lowest cost rotor blade 6 construction), this centrifugal force may be modeled as applied to the midpoint of the rotor blade 6 between the top 15 and bottom 17, in a direction away from the axis of rotation 12. Because length D is larger than length C, the midpoint of the rotor blade 6 occurs below the hinge pivot point 5, which causes the bottom length 16 to rotate outwardly (e.g. away from axis 12) and the top length 14 to rotate inwardly (e.g. toward axis 12) as the centrifugal force is increased. The centrifugal force is increased as the rotational velocity of the rotor arms 4 increases, which is in turn caused by increased wind speeds. Thus, at higher wind speeds, the top 15 of the rotor blade 6 rotates inwardly toward the axis of rotation 12, thereby reducing the swept area or the rotor area 18, according to embodiments of the present invention. This configuration permits a relatively steady energy generation over a wide range of wind speeds, as a result of the rotor blades 6 automatically adjusting the rotor area as described, according to embodiments of the present invention.

According to embodiments of the present invention, the automatic adjustment of the angle of the rotor blades 6 with respect to the rotor arms 4 is completely passive, and involves a minimal amount of hardware. According to embodiments of the present invention, the hinge joint 5 is the only point of contact between the rotor blade 6 and any other part of the vertical axis wind turbine 100, including the rotor arm 4, hub 3, and/or base 1. According to such embodiments, there are no stabilizers or wires or frames that attach to the rotor blade 6; instead, the sole mechanism that governs and/or constrains the movement of the rotor blade 6 is the hinge 5.

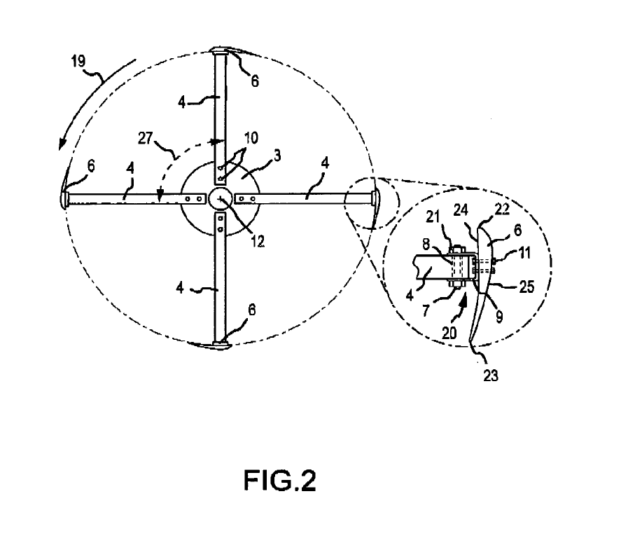

FIG. 2 illustrates a top plan view of a vertical axis wind turbine 100 and an enlarged view of a rotor blade 6 and hinge joint 5, according to embodiments of the present invention. Arrow 19 indicates the direction of rotation; however, one of ordinary skill in the art, based on the present disclosure, will recognize that the vertical axis wind turbine 100 may be configured to rotate in the opposite direction, and/or to rotate in two different directions, according to embodiments of the present invention.

FIG. 2 also illustrates an enlarged view of a hinge joint 20, according to embodiments of the present invention. Hinge joint 20 includes a hinge bearing 8, which may extend through and/or be coupled with the rotor arm 4 as shown. A U-shaped blade attachment bracket 9 may be coupled with the rotor blade 6, for example using bracket attachment bolts 11, according to embodiments of the present invention. The sides of the blade attachment bracket 9 may include holes formed therein, such that when the blade attachment bracket 9 is placed over the outer end of the rotor arm 4, the holes in the bracket 9 align with the hole through bearing 8, according to embodiments of the present invention. Bolt 7 may be placed through the bracket 9 and bearing 8 and secured with a nut 21 as shown, according to embodiments of the present invention.

Although a particular hinge joint 20 is illustrated, one of ordinary skill in the art, based on the present disclosure, will appreciate the numerous other ways for pivotably coupling the rotor blade 6 with the rotor arm 4, according to embodiments of the present invention. For example, a single-sided bracket may be used instead of a U-shaped bracket 9. Also, the U-shaped bracket may instead extend from the rotor arm 4 and mate with a bearing element that is coupled with or attached to the rotor blade 6, according to embodiments of the present invention. A shaft and/or pin and/or the like may be used instead of a bolt 7 and nut 21 combination, according to embodiments of the present invention. According to some embodiments of the present invention, the bearing element 8 is omitted, and the bolt 7 or shaft simply rotates within an aperture in the rotor arm 4.

The rotor blade 6 includes a leading edge 22, a trailing edge 23, an inner surface 24 extending from the leading edge 22 to the trailing edge 23, and an outer surface 25 extending from the leading edge 22 to the trailing edge 23, according to embodiments of the present invention. According to embodiments of the present invention, the outer surface 25 is longer than the inner surface 24 between the leading edge 22 and trailing edge 23 in a plane orthogonal to the axis of rotation (such as, for example, the plane according to which the view of FIG. 2 is taken). According to some embodiments of the present invention, the cross-sectional shape of the rotor blade 6 taken along an orthogonal plane is substantially aerodynamic, and/or substantially airfoil-shaped.

Because the vertical axis wind turbine 100 shown in FIG. 2 includes four rotor arms 4 and four rotor blades 6, the angle 27 formed between adjacent rotor arms 4 in the plane that is substantially orthogonal to the axis 12 is approximately ninety degrees. According to embodiments of the present invention, the device 100 has two rotor arms 4. According to other embodiments of the present invention, the device 100 has three, four, five, six, seven, eight, nine, ten, or more rotor arms. According to embodiments of the present invention, the angle 27 formed between adjacent rotor arms 4 is equal or substantially equal as measured between each set of adjacent rotor arms 4, according to embodiments of the present invention. According to embodiments of the present invention, the rotor arms 4 are arranged in a radially symmetrical pattern about the axis 12.

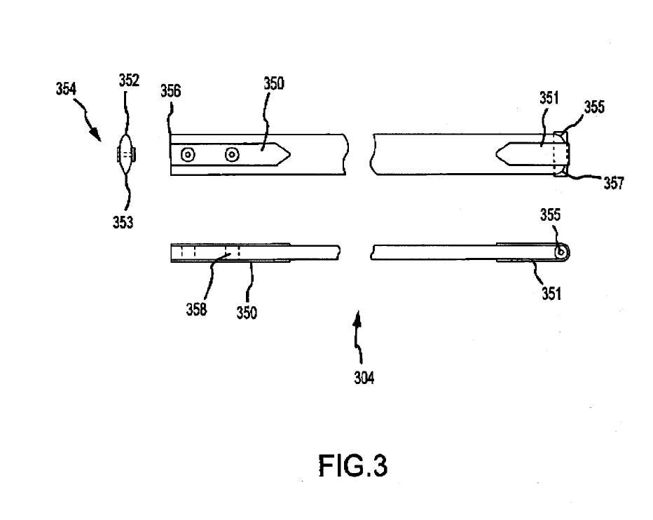

FIG. 3 illustrates a top, side, and cross-sectional view of an alternative rotor arm 304, according to embodiments of the present invention. Rotor arm 304 includes a cross-sectional shape 354 which is more aerodynamic than a square or rectangular cross-sectional shape. Cross-sectional shape 354 may, for example, be airfoil-shaped and/or include a leading edge 352 and a trailing edge 353. Cross-sectional shape 354 may be teardrop shaped, according to embodiments of the present invention. A bracket 350, such as, for example, a U-shaped bracket 350 as illustrated in FIG. 3, may be placed over an inner end 356 of the rotor arm 304, and bolted to the hub 3 via holes 358 formed through the bracket 350 and the inner end 356 of rotor arm 304, according to embodiments of the present invention. Another bracket 351, such as, for example, a U-shaped bracket 351 as illustrated in FIG. 3, may be placed over an outer end 357 of rotor arm 304, and over a bearing element 355 and attached to the rotor arm 304 to hold the bearing element 355 to the rotor arm 304, according to embodiments of the present invention. The brackets 350, 351 may be attached to the rotor arm 304 via screws, bolts, adhesive, and other attachment mechanisms, according to embodiments of the present invention.

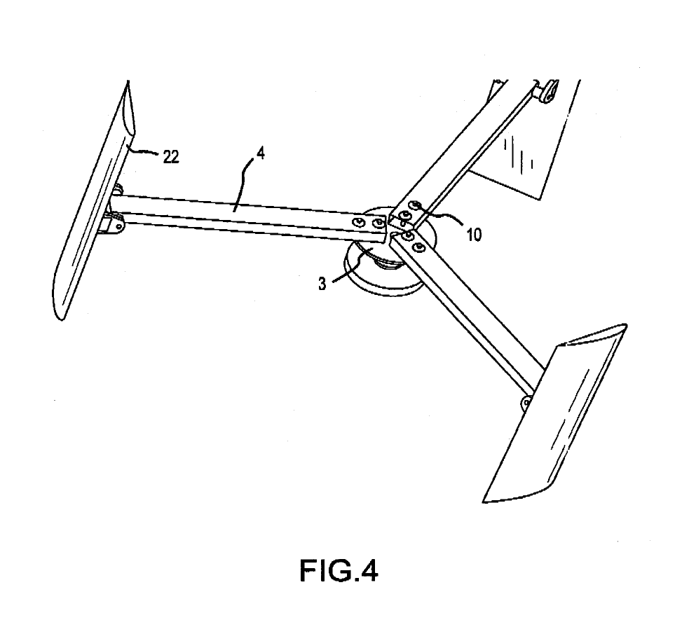

FIG. 4 illustrates a perspective view of a vertical axis wind turbine 400 having three rotor arms 4 and three rotor blades 6, according to embodiments of the present invention. FIG. 4 also illustrates that washers and/or spacers 26 may be placed between the rotor arm 4 and the bracket 9. Washers 26 may facilitate rotation of the rotor blade 6 about the rotor arm 4, according to embodiments of the present invention. A hardened washer 26 may be used between bracket 9 and bearing 8, according to embodiments of the present invention. Packed bearings and/or self-lubricated bearings may be used at hinge joint 20, according to embodiments of the present invention. According to embodiments of the present invention, a hinge pin is fixedly coupled on the mounting bracket 9, and the bearing 8 is located on the outer end of the rotor arm 4, and a larger surface area is created when bushings are used. Ball and/or roller bearings may also be used.

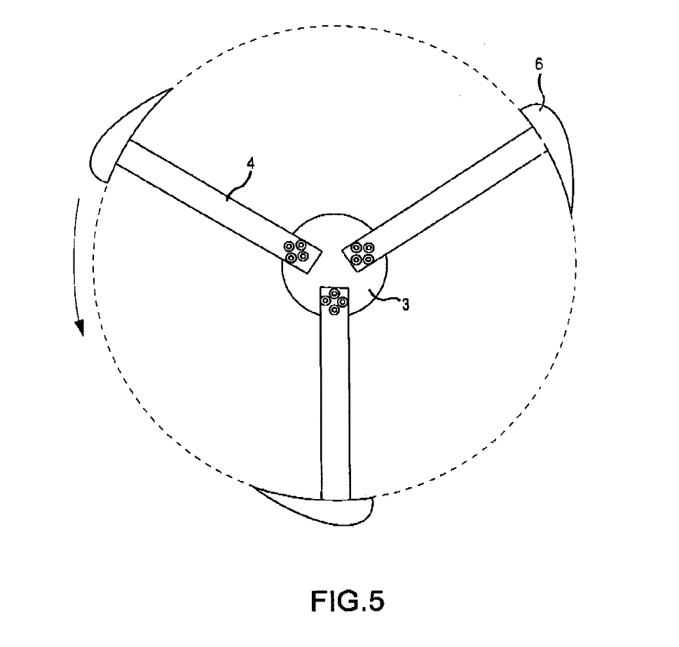

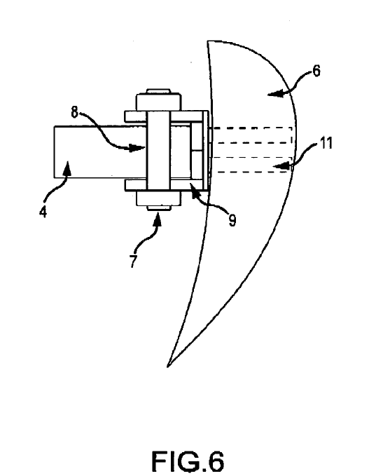

FIG. 5 illustrates a top plan view of a vertical axis wind turbine having three rotor arms 4 and three rotor blades 6, similar to the vertical axis wind turbine of FIG. 4, according to embodiments of the present invention. FIG. 6 illustrates an enlarged view of one of the rotor blades of the vertical axis wind turbine of FIG. 5, according to embodiments of the present invention. An uneven, or odd, number of rotor arms 4 may be used in order to promote self-starting and continuous operation of the turbine 100 in wind, according to embodiments of the present invention. As such, a turbine 100 with an odd number of rotor arms 4 and rotor blades 6 may avoid being held stationary by a balanced wind at a certain angle and speed, according to embodiments of the present invention.

According to embodiments of the present invention, device 100 is totally controlled by natural forces of wind and gravity; such a configuration minimizes wear of accessory controls and minimizes unbalance of the rotating member 3, because additional accessories and complicated support and/or stabilization mechanisms are not included in the system.

Embodiments of the present invention accomplishes rotor area change using only one moving part (e.g. the rotor blade 6), whose angle and area change are accomplished using only the natural forces. This permits production of energy in low wind speed areas and in extreme high wind conditions, and also greatly reduces the parts count, complexity, and cost of manufacturing and maintenance for wind turbine 100, according to embodiments of the present invention. Embodiments of the present invention make it possible to generate energy in all classes of wind from Class 1 to Class 7 and in typhoon and hurricane areas, without damage or damage to the point of failure, with its ability to use much larger rotor area for low wind areas and to control or reduce the rotor area for higher wind conditions. The variable area performance reduces the exposed rotor area for high wind conditions, which allows installation much closer to actual loads in lower or higher wind speeds, according to embodiments of the present invention.

The plurality of rotor arms 4 can be any number of rotor arms, depending on the specific wind regime. The attachment of the rotor blade 6 to the rotor arm 4 may be accomplished in several ways. The rotor blades 6, hinges 20, and rotor arms 4 are attached to the hub 3 in such a manner that they are mechanically balanced and rotate freely around the axis 12, according to embodiments of the present invention. A rotational dampener may optionally be incorporated in the hinge 20. Such a rotational dampener may impart a rotational friction, located at or on the rotor hinge pin (for example, at the bolt 7), with rotational friction dampening operation similar to a Scott Model Tail wheel used on many popular aircraft. The various components of the turbine 100 may be constructed with fiberglass, aluminum, steel, or other structural materials in nearly any combination.

Embodiments of the present invention, using only the natural centrifugal/centripetal forces, together with the forces of the wind on the rotor blade 6/aerofoil, controls the area of the rotor exposed to the wind, which in turn controls the power output and the stresses applied by the wind. The rotor area exposed to the wind determines power production, and is also a source of stress and wind loading on a wind machine. Embodiments of the present invention control the area of the rotor blades exposed to the wind, which in turn controls the exponentially increasing, and potentially damaging, forces applied to, or on, the machine from the wind and other forces.

This method of wind turbine 100 construction permits the use of a much larger rotor area, which makes it feasible and commercially viable in Class 2 (9.8 mph/4.5 mps) as well as higher wind areas, including Class 7 (9.4 mps). This results in stress loads from the wind and other forces being held nearly constant throughout the operational range of the turbine 100 (for example, over all wind speeds).

Embodiments of the present invention feature a reduced component part count and reduced complexity compared with existing turbine designs, which often require brakes, braces, and complex control systems to avoid excess speed and/or to halt rotation in lower wind speeds. According to embodiments of the present invention, device 100 does not require either blade feathering or external braking. Fewer numbers of parts also reduces overall maintenance. Existing vertical axis wind turbines suffer from extreme centrifugal forces as wind speeds increase, which, in turn, requires substantial bracing on the rotor blades to counteract such forces and to attempt to prevent the rotor blade from buckling at the mounting point. However, embodiments of the present invention such forces are re-directed; in high wind speeds (and thus high rotational speeds of the rotor blades 6 about the axis 12), the rotor blades 6 run substantially parallel to the centrifugal forces and the rotor blades 6 become, when horizontal, much like helicopter blades. The centrifugal forces then become a large component of the strength and/or stability and/or balance of the rotor blades 6, according to embodiments of the present invention.

The natural rotational balance of the rotor blades 6 is not restricted by bracing of any type or form, according to embodiments of the present invention. Bracing is not required because, in high wind speeds, the rotor blade 6 strength is increased in much the same way as a helicopter rotor. According to some embodiments of the present invention, a locking mechanism may optionally be used to hold the rotor blades 6 in a substantially vertical position until the rotor arms 4 reach a selected rotational speed, at which point the rotor blade 6 will be released from the locking mechanism and permitted to automatically adjust its angle as described, above. Such a locking/release mechanism may be activated by centrifugal forces, and may be similar to a gate-latch type latching mechanism commonly used for fence gates, according to embodiments of the present invention.

Embodiments of the present invention allow the rotor blade 6 to continuously change its angle to meet the demands of the wind loading on the machine 100 by reducing the cross sectional area (e.g. the area exposed to the wind), thereby allowing only enough exposed area to generate the desired amount of energy and relieving any stress above that which is required for optimum power output.

According to one embodiment of the present invention, the turbine 100 includes a stop, either mounted to the rotor arm 4, the rotor blade 6, and/or included within the hinge joint 20, which is configured to prevent rotation of the lower end 17 of the rotor blade 6 toward the axis of rotation 12 beyond a substantially vertical position of the rotor blade 6.

According to one embodiment of the present invention, the turbine 100 includes a spring (such as, for example, a torsion spring positioned at the pivot point 5) that is configured to bias the rotor blade toward 6 a substantially upright position (as illustrated in the solid lines of FIG. 1).

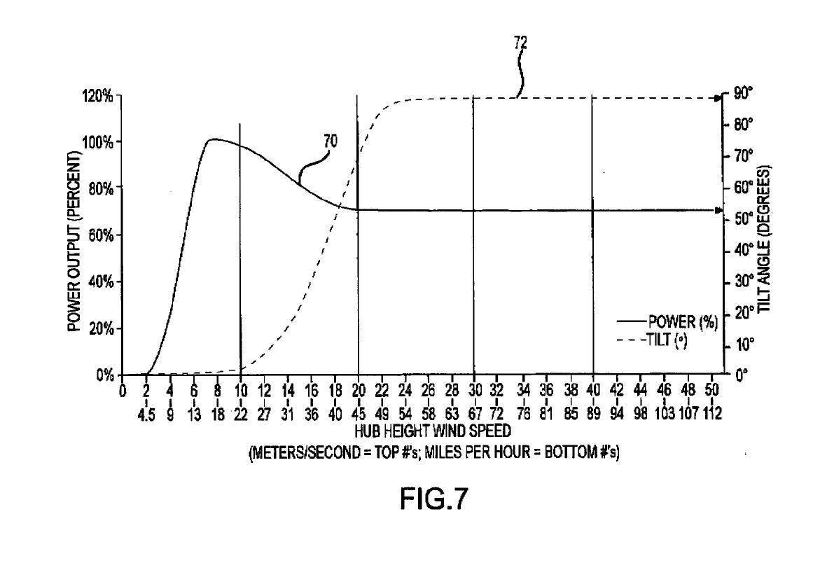

FIG. 7 depicts an anticipated power output curve 70 (as a percentage of maximum power output for a given turbine 100 configuration) and an anticipated tilt angle curve 72 over a range of wind speeds, according to embodiments of the present invention. FIG. 7 illustrates that the vertical axis wind turbine 100 may be configured to automatically accommodate energy generation for wind speeds ranging from 2.5 meters per second to 50 meters per second. FIG. 7 also illustrates that the vertical axis wind turbine 100 may be configured to automatically accommodate energy generation at eighty to one hundred percent of maximum energy generation over wind speeds ranging from six to fifteen meters per second.

FIG. 7 also illustrates that the vertical axis wind turbine 100 may be configured to automatically accommodate energy generation at sixty to one hundred percent of maximum energy generation over wind speeds ranging from six to twenty-two meters per second, and over wind speeds ranging from six to thirty-six meters per second. FIG. 7 also illustrates that, during operation, the upper end 15 may be configured to begin rotating toward the axis of rotation 12 at wind speeds greater than seven meters per second. FIG. 7 also illustrates that, during operation, a tilt angle of the rotor blade 6 with respect to the rotor arm 4 may be configured to be greater than eighty degrees at a wind speed of twenty-two meters per second.

FIG. 7 also illustrates that, as the rotor blade 6 tilt angle approaches ninety degrees (e.g. substantially horizontal or laying substantially flat against the rotor arm 4), the power output remains substantially constant over a large range of very high wind speeds (e.g. from twenty-two meters per second up to and above fifty meters per second), according to embodiments of the present invention.

According to embodiments of the present invention, rotation of the rotor blade 6 about the rotor arm 4 is neither controlled nor facilitated by a computer or electronic control system. According to embodiments of the present invention, rotation of the hub 3 is neither controlled nor facilitated by a computer or electronic control system. According to embodiments of the present invention, the only forces acting on the rotor blade 6 during operation are those of gravity, wind, centripetal forces, and friction at the first hinge joint 20, with such centripetal forces being created due to the rotation of the rotor arms 4 by the wind. In other words, in some embodiments of the present invention, there are no springs or cables acting on the rotor blade 6.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

1. A vertical axis wind turbine comprising:
a hub configured to rotate about an axis of rotation substantially aligned with a gravitational force;
a first rotor arm rigidly coupled to the hub;
a second rotor arm rigidly coupled to the hub;
a first rotor blade pivotably coupled to the first rotor arm at a first hinge joint, such that the first rotor blade rotates freely about the first rotor arm at the first hinge joint, the first rotor blade having a first upper end and a first lower end; and
a second rotor blade pivotably coupled to the second rotor arm at a second hinge joint, such that the second rotor blade rotates freely about the second rotor arm at the second hinge joint, the second rotor blade having a second upper end and a second lower end;
wherein a first length of the first rotor blade from the first hinge joint to the first lower end is longer than a second length of the first rotor blade from the first hinge joint to the first upper end,
wherein a third length of the second rotor blade from the second hinge joint to the second lower end is longer than a fourth length of the second rotor blade from the second hinge joint to the second upper end,
wherein the first hinge joint is the only attachment between the first rotor blade and any other part of the vertical axis wind turbine, and
wherein the second hinge joint is the only attachment between the second rotor blade and any other part of the vertical axis wind turbine.

2. The vertical axis wind turbine of claim 1, wherein the axis of rotation is a first axis of rotation, wherein the first rotor blade pivots about a second axis of rotation with respect to the first rotor arm, wherein the second rotor blade pivots about a third axis of rotation with respect to the second rotor arm, wherein the second and third axes of rotation are orthogonal to the first axis of rotation.

3. The vertical axis wind turbine of claim 2, wherein the second and third axes of rotation share a plane that is orthogonal to the first axis of rotation.

4. The vertical axis wind turbine of claim 2, wherein the second and third axes of rotation are parallel.

5. The vertical axis wind turbine of claim 1, further comprising:
a third rotor arm rigidly coupled to the hub; and
a third rotor blade pivotably coupled to the third rotor arm at a third hinge joint, such that the third rotor blade rotates freely about the third rotor arm at the third hinge joint,
wherein a first angle formed between the first and second rotor arms is equal to a second angle formed between the second and third rotor arms.

6. The vertical axis wind turbine of claim 5, further comprising:
a fourth rotor arm rigidly coupled to the hub; and
a fourth rotor blade pivotably coupled to the fourth rotor arm at a fourth hinge joint, such that the fourth rotor blade rotates freely about the fourth rotor arm at the fourth hinge joint,
wherein a third angle formed between the third and fourth rotor arms is equal to the first angle and to the second angle.

7. (canceled)

8. The vertical axis wind turbine of claim 1, wherein the first rotor blade comprises a leading edge, a trailing edge, an inner surface extending from the leading edge to the trailing edge, and an outer surface extending from the leading edge to the trailing edge, wherein the outer surface is longer than the inner surface between the leading and trailing edges in a plane orthogonal to the axis of rotation.

9. The vertical axis wind turbine of claim 1, wherein the first rotor blade is adapted to rotate with respect to the first rotor arm from a substantially vertical position to a substantially horizontal position.

10. The vertical axis wind turbine of claim 1, wherein the first rotor blade is adapted to rotate with respect to the first rotor arm from a substantially upright position to a position in which the first rotor blade is substantially flat against the first rotor arm.

11. (canceled)

12. The vertical axis wind turbine of claim 11, wherein the first and second rotor blades are configured to automatically reduce a swept area of the vertical axis wind turbine by at least ninety percent during operation.

13. The vertical axis wind turbine of claim 1, wherein the first and second rotor blades are configured to automatically accommodate energy generation for wind speeds ranging from 2.5 meters per second to 50 meters per second.

14. The vertical axis wind turbine of claim 1, wherein the vertical axis wind turbine is configured to automatically accommodate energy generation at eighty to one hundred percent of maximum energy generation over wind speeds ranging from six to fifteen meters per second.

15. The vertical axis wind turbine of claim 1, wherein the vertical axis wind turbine is configured to automatically accommodate energy generation at sixty to one hundred percent of maximum energy generation over wind speeds ranging from six to twenty-two meters per second.

16. (canceled)

17. The vertical axis wind turbine of claim 1, wherein during operation the first upper end is configured to begin rotating toward the axis of rotation at wind speeds greater than seven meters per second.

18. The vertical axis wind turbine of claim 1, wherein during operation a tilt angle of the first rotor blade with respect to the first rotor arm is configured to be greater than eighty degrees at a wind speed of twenty-two meters per second.

19. (canceled)

20. (canceled)

21. The vertical axis wind turbine of claim 1, wherein the only forces acting on the first rotor blade during operation are those of gravity, wind, centripetal forces, and friction at the first hinge joint.

22. The vertical axis wind turbine of claim 1, wherein the first hinge joint is the only point of contact between the first rotor blade and any other part of the vertical axis wind turbine.

23. The vertical axis wind turbine of claim 1, further comprising a stop configured to prevent rotation of the first lower end toward the axis of rotation beyond a substantially vertical position of the first rotor blade.

24. The vertical axis wind turbine of claim 1, wherein the first hinge joint comprises a spring configured to bias the first rotor blade toward a substantially upright position.

25. A vertical axis wind turbine comprising:
a hub configured to rotate about an axis of rotation substantially aligned with a gravitational force direction;
a first rotor arm rigidly coupled to the hub;
a second rotor arm rigidly coupled to the hub;
a first rotor blade pivotably coupled to the first rotor arm at a first hinge; and
a second rotor blade pivotably coupled to the second rotor arm at a second hinge;
wherein the first hinge is the only attachment between the first rotor blade and any other part of the vertical axis wind turbine,
wherein the second hinge is the only attachment between the second rotor blade and any other part of the vertical axis wind turbine, and
wherein rotation of the hub about the axis of rotation by a wind force on the first and second rotor blades generates energy.

26-50. (canceled)
